(19) United States
(12) Patent Application Publication
(10) Pub. No.: US 2025/0180521 A1
(43) Pub. Date: Jun. 5, 2025

(54) METHOD FOR ENHANCING SHEAR WAVE IMAGING BASED ON ACOUSTIC VORTEX

(71) Applicant: NATIONAL TSING HUA UNIVERSITY, Hsinchu (TW)

(72) Inventors: Chih-Kuang YEH, Hsinchu (TW); Wei-Chen LO, Hsinchu (TW)

(21) Appl. No.: 18/967,865

(22) Filed: Dec. 4, 2024

Related U.S. Application Data
(60) Provisional application No. 63/605,599, filed on Dec. 4, 2023.

(51) Int. Cl. G01N 29/34; G01N 29/04; G01N 29/06

(52) U.S. Cl. CPC G01N 29/346; G01N 29/043; G01N 29/0654; G01N 2291/02475; G01N 2291/02827; G01N 2291/0422; G01N 2291/106

(57) ABSTRACT

A method for enhancing shear wave imaging based on an acoustic vortex includes the following steps. An ultrasonic beam in an acoustic vortex waveform is transmitted to a target tissue through an ultrasonic transducer. An original wave source generated by the ultrasonic beam is sensed through the target tissue. The original wave source forms a shear wave source in a unit periodicity. The at least one shear wave source responds to generate a constructive interference shear wave source. A shear wave is generated through the constructive interference shear wave source. Tissue characteristic information is obtained based on the shear wave imaging. An image of a displacement generated by the shear wave is drawn through the tissue characteristic information.

### BACKGROUND

### Technical Field

The present invention relates to a method for enhancing shear wave imaging based on an acoustic vortex. In the method for enhancing the shear wave imaging based on an acoustic vortex, an acoustic vortex waveform is used for inducing the shear wave imaging and a constructive interference shear wave, to increase an axial particle displacement for a tissue.

### Related Art

An elasticity characteristic of a tissue may be used as an index for diagnosing a disease. For example, a doctor detects tissues such as thyroid gland and mammary gland through palpation. Therefore, elasticity information of the tissue in a clinic diagnosis is important. However, a palpation manner can only determine stiffness of the tissue, and is subjective.

Therefore, an ultrasonic non-invasive elastography technology is gradually used for representing the elasticity information of the tissue, and presenting elasticity distribution in the tissue by using images. In addition, shear wave imaging, as a non-invasive ultrasound technology, is used for assessing liver fibrosis, pathological changes of mammary gland, stiffness of cardiac muscle tissue, and the like. However, in a conventional technology, an acoustic radiation force impulse (ARFI) is used to push the tissue to generate shear wave volume imaging. The conventional technology faces a challenge of a limited field of view of an elasticity image.

### SUMMARY

The present invention provides a method for enhancing shear wave imaging based on an acoustic vortex. An objective of the method is that there is a mechanism for inducing of a constructive interference shear wavefront (constructive interference shear wavefront) through the acoustic vortex, so that a stronger tissue displacement can be generated without increasing sound pressure and push impulse time. The stronger displacement means that a stronger shear wave amplitude can be generated, and a transmission distance of the shear wave is increased. Therefore, an objective of expanding a field of view range of elastography is achieved.

The present invention provides a method for enhancing shear wave imaging based on an acoustic vortex, comprising the following steps. An ultrasonic beam in an acoustic vortex waveform is transmitted to a target tissue through an ultrasonic transducer. An original wave source generated by the ultrasonic beam is sensed through the target tissue. The original wave source forms at least one shear wave source in a unit periodicity. The at least one shear wave source responds to generate a constructive interference shear wave source. A shear wave is generated through the constructive interference shear wave source. Tissue characteristic information is obtained based on the shear wave. An image of a displacement generated by the shear wave is drawn through the tissue characteristic information.

In an embodiment of the present invention, the ultrasonic transducer comprises an ultrasonic probe emitting an acoustic vortex, and the ultrasonic probe is configured to generate a plurality of ultrasonic beams to transmit the ultrasonic beams to the target tissue.

In an embodiment of the present invention, the ultrasonic probe is a single array source or an array probe.

In an embodiment of the present invention, a central frequency of the ultrasonic beam is in a range of 1 MHz to 10 MHz.

In an embodiment of the present invention, the step of that the original wave source forms at least one shear wave source in a unit periodicity further comprises that at least one action area is correspondingly established based on transverse acoustic field distribution of the original wave source.

In an embodiment of the present invention, the step of that at least one action area is correspondingly established based on transverse acoustic field distribution of the original wave source further comprises that the at least one shear wave source generates constructive interference in the action area.

In an embodiment of the present invention, the step of that the at least one shear wave source generates constructive interference in the action area further comprises that the at least one shear wave source increases a displacement for the target tissue because of the constructive interference, to improve amplitude strength of a shear wave.

In an embodiment of the present invention, the step of that a shear wave is generated through the constructive interference shear wave source further comprises that elasticity of the target tissue is determined through the shear wave

In an embodiment of the present invention, the tissue characteristic information comprises at least one of arrival time of the shear wave, a peak displacement of the shear wave, an axial displacement of the shear wave, rise time of the shear wave, fall time of the shear wave, and a normalized distribution diagram of the shear wave.

Effects of the present invention are as follows. A two-dimensional array with a central frequency of 5 MHz transmits a vortex waveform to induce shear wave elastography. Four shear wave sources are generated at different positions in a transverse direction at a time interval of a quarter periodicity (50 ns) through a phase delay characteristic of a waveform, to induce a constructive interference shear wavefront in the transverse direction and increase a displacement generated in a tissue without increasing ultrasonic wave output. Therefore, a stronger shear wave amplitude is generated, a transmission distance of the shear wave is increased, and an objective of expanding a field of view range of elastography is achieved.

### BRIEF DESCRIPTION OF THE DRAWINGS

FIG. 1A is a schematic diagram of an ultrasonic system according to various embodiments of the present invention;

FIG. 1B is a schematic diagram of an ultrasonic system according to various embodiments of the present invention;

FIG. 1C is a schematic diagram of an ultrasonic system according to various embodiments of the present invention;

FIG. 1D is a schematic diagram of an ultrasonic system according to various embodiments of the present invention;

FIG. 2 is a schematic diagram of axial distribution of an acoustic vortex according to various embodiments of the present invention;

FIG. 3 is a schematic diagram of transverse distribution of an acoustic vortex according to various embodiments of the present invention;

FIG. 4 is a schematic diagram of an acoustic vortex radiation force according to various embodiments of the present invention;

FIG. 5 is a schematic diagram of the acoustic vortex radiation force according to FIG. 4;

FIG. 6 is a schematic diagram of a multi-point shear wave source according to various embodiments of the present invention;

FIG. 7 is a schematic diagram of a shear wavefront transmission according to various embodiments of the present invention; and

FIG. 8 is a schematic diagram of an exemplary axial particle displacement according to the present invention.

### DETAILED DESCRIPTION

To make the foregoing features and advantages of the present invention more obvious and understandable, embodiments are described in detail below with reference to the accompanying drawings.

It should be noted that, in physics, interference refers to a phenomenon in which two or more waves are superimposed when overlapping in space, to form a new waveform. When two waves are transmitted in a same medium and overlap, a particle of the medium in an overlapping range is simultaneously affected by the two waves. If an amplitude of the wave is not large, a vibrational displacement of the particle of the medium in the overlapping range is equal to a vector sum of a displacement caused by waving. This is referred to as a wave overlapping principle. If wave peaks or wave troughs of the two waves reach a same position simultaneously, it is referred to that the two waves are in phase at the position. An interference wave generates a maximum amplitude, and this is referred to as constructive interference.

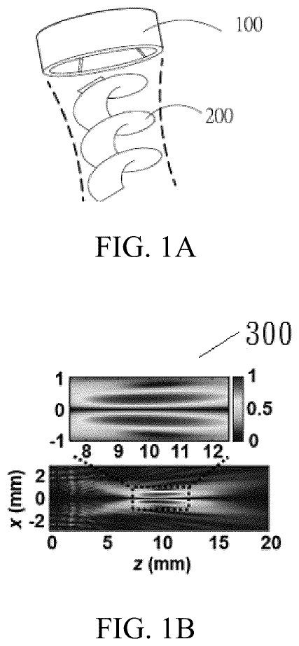

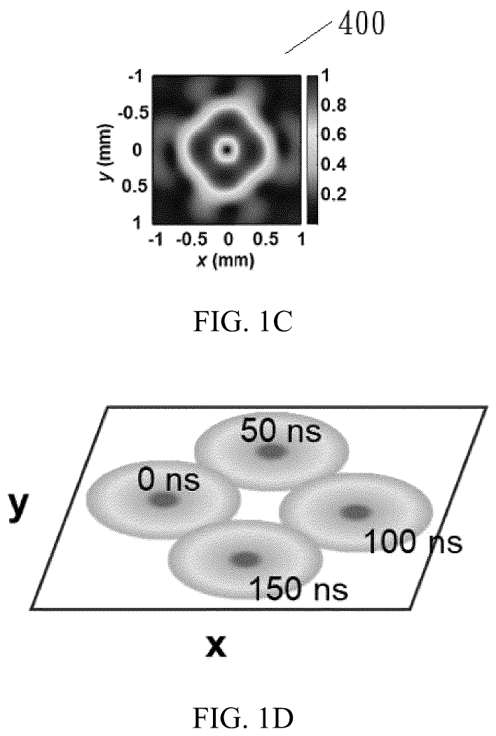

FIG. 1A to FIG. 1D are schematic diagrams of ultrasonic systems according to various embodiments of the present invention.

An acoustic vortex waveform is a technology for regulating a phase delay of a transmitted waveform. An acoustic wave having a spiral phase structure generates a phase difference in a range of 0 to 2 mx radians on an axial direction in a wavefront transmission direction, where m represents a spiral order value (m=1, 2, 3, . . . ), and may generate a spiral-shape wavefront. The acoustic vortex waveform divides a component of a probe into a plurality of blocks for transmitting waveforms, and regulates a phase difference of each block. The formula is as follows:

$${ϕ}_{n} = \frac{2 π m ( n - 1 )}{{N}_{B}}$$

where ϕₙ is a phase radian corresponding to each block, NB is a total block quantity, and n=1, 2, 3, . . . , NB.

In some embodiments, as shown in FIG. 1A, Vortex (m=1) is used as an example. An ultrasonic beam in an acoustic vortex waveform 200 is transmitted to a target tissue through an ultrasonic transducer 100 with a central frequency of 5 MHz and having 11×11 components, components in a sixth row and in a sixth column are turned off, and only remaining 100 components are driven, so that component distribution presents four blocks divided in a cross, including blocks of upper left, upper right, lower left, and lower right. The four blocks are further evenly divided into eight blocks, to form component blocks divided in an eight-spoked asterisk-like shape.

Phases corresponding to components of the eight blocks are 0 π radians, 0.25 π radians, 0.5 π radians, 0.75 π radians, 1π radians, 1.25 π radians, 1.5 π radians, and 1.75 π radians respectively in a clockwise direction.

This phase difference causes destructive interference of the acoustic wave in a transmission process, so that an empty axis with pressure of almost zero is formed along a center of the axial direction, as shown in axial energy distribution 300 in FIG. 1B.

In this case, a result of transverse acoustic field distribution is annular distribution, where high-pressure distribution exists around the empty axis, has an inward action force, and is configured to manipulate micro-particles, as shown in transverse energy distribution 300 in FIG. 1C.

However, for a vortex having a larger value of m, it represents that there is m spiral distribution along the center of the axial direction. Consequently, a size of the empty axis increases as the value of m increases.

It can be known from the transverse acoustic field distribution formed by the acoustic vortex waveform that there is strong energy distribution at four positions of the annular distribution, namely, an upper position, a lower position, a left position, and a right position. In combination with phase delay regulation of the waveform, it is considered that four main action positions may be generated in a transverse direction in one periodicity. From a perspective of an action position of a pulse, for a pulse signal with a central frequency of 5 MHz and a periodicity of 200 ns, when there are four main action positions, it is equivalent to that there are four push pulses, and four shear wave sources are formed in the transverse direction at a time interval of 50 ns, as shown in a schematic diagram of a plurality of shear wave sources in FIG. 1D.

Therefore, it can be learned that the acoustic vortex has a capability of inducing the plurality of shear wave sources in the transverse direction. Compared with that an acoustic radiation force impulse generates only one shear wave source in the transverse direction, the acoustic vortex has a mechanism for inducing a constructive interference shear wavefront, and can generate a stronger tissue displacement without increasing sound pressure and push impulse time, so that strength of the shear wave is greater than strength induced by the acoustic radiation force impulse.

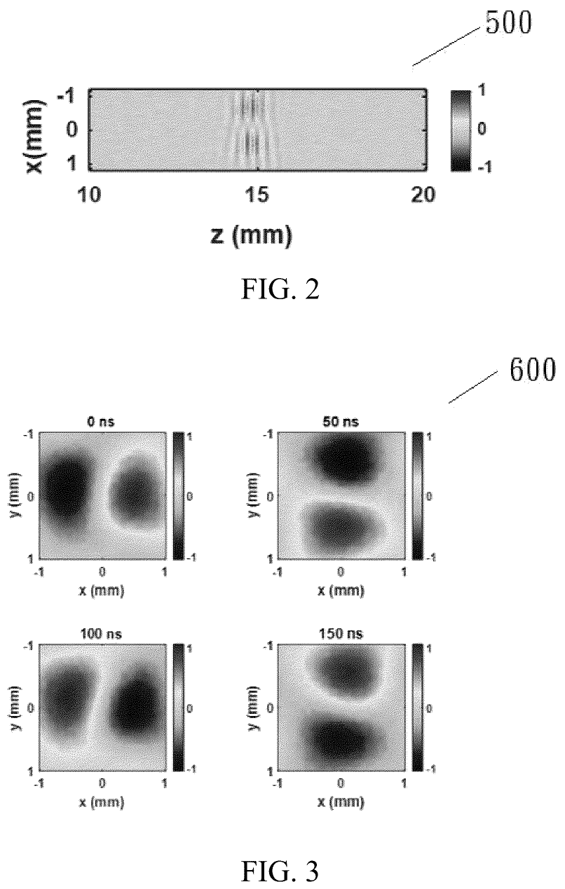

Referring to both FIG. 2 and FIG. 3, FIG. 2 is a schematic diagram of axial distribution of an acoustic vortex according to various embodiments of the present invention, and FIG. 3 is a schematic diagram of transverse distribution of an acoustic vortex according to various embodiments of the present invention.

A transmission result of an acoustic vortex wavefront in space with time is obtained through actual measurement. It is observed from a transmission result of an axial wavefront that positive and negative pressures of two wavefronts of the acoustic vortex are staggered, it indicates that there is a phase difference between the two wavefronts, as shown in a schematic diagram of acoustic field scanning axial distribution 500 in FIG. 2.

In a transverse transmission result of the wavefront at a focus position, four main action positions of the acoustic vortex in a periodicity in a transverse direction may be observed, as shown in a schematic diagram of acoustic field scanning transverse distribution 600 in FIG. 3.

Actually, the positive and negative pressures of the wavefront are staggered to form a pressure gradient, generate an acoustic radiation force, and push a particle in a tissue from the negative pressure to the positive pressure to generate movement. A main acoustic radiation force of an acoustic vortex waveform moves in a z-axis direction, and it can be known from the transverse transmission result of the acoustic vortex that the acoustic vortex further has a torsional acoustic radiation force in a transverse direction, and is applied at different positions in the tissue.

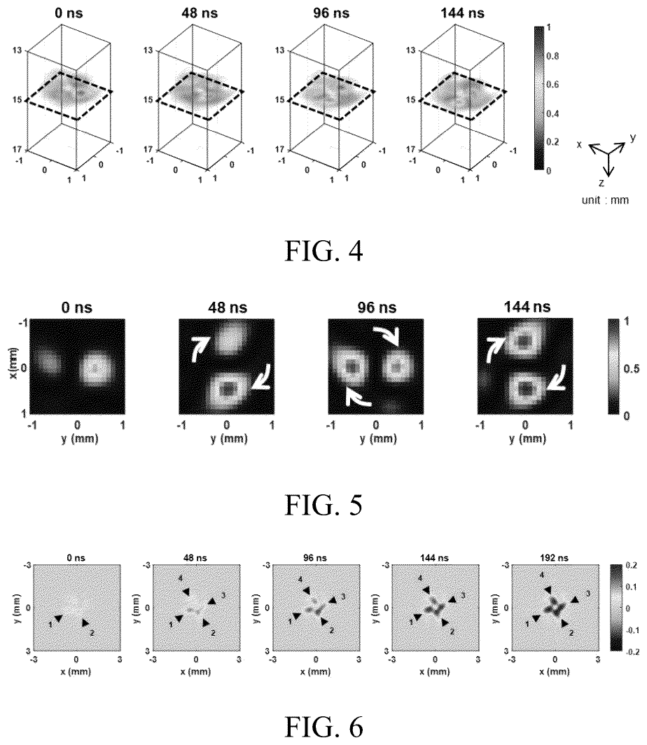

Referring to both FIG. 4 and FIG. 5, FIG. 4 is a schematic diagram of an acoustic vortex radiation force according to various embodiments of the present invention, and FIG. 5 is a schematic diagram of the acoustic vortex radiation force according to FIG. 4.

FIG. 4 shows distribution of the acoustic radiation force acting in an axial direction in one periodicity in three-dimensional space. An induced acoustic radiation force exists in the three-dimensional space in a range of 0 ns to 200 ns. A focus position is cut as shown in FIG. 5, for example, a change of an action position is observed in transverse two-dimensional sections at areas marked by black boxes in FIG. 4.

It can be known from FIG. 4 and FIG. 5 that an action area on which the acoustic radiation force is acted is in a range of 2 mm×2 mm in a transverse direction, and coincides with an action area of a wavefront. Therefore, it is determined that this area is indeed subjected to the force of the acoustic vortex.

Due to a twisted wavefront of the acoustic vortex, the acoustic radiation force is unevenly distributed in a tissue of the action area, and changes periodically. In addition, the change is caused because of an acoustic pressure gradient of the twisted wavefront of the acoustic vortex, so that forces of different directions and strength are acted at each position in the tissue. Therefore, it may be predicted based on a result of the acoustic radiation force of the acoustic vortex that a plurality of shear wave sources may be generated in the transverse direction.

Based on the foregoing result, it indicates that the acoustic radiation force generated by an acoustic vortex waveform in the tissue is applied at different positions in one periodicity.

Therefore, it is further simulated that when the tissue is subjected to the acoustic radiation force, an axial particle at this position vibrates, to form a corresponding shear wave source.

Referring to FIG. 6, FIG. 6 is a schematic diagram of a multi-point shear wave source according to various embodiments of the present invention.

When an acoustic radiation force generated by an acoustic vortex waveform in a target tissue and a shear wave source generated in a range of 0 ns to 200 ns are observed at a focus position, it can be learned that an acoustic vortex generates displacements at four positions, that is, the acoustic vortex waveform generates, in space, four shear wave sources changing with time.

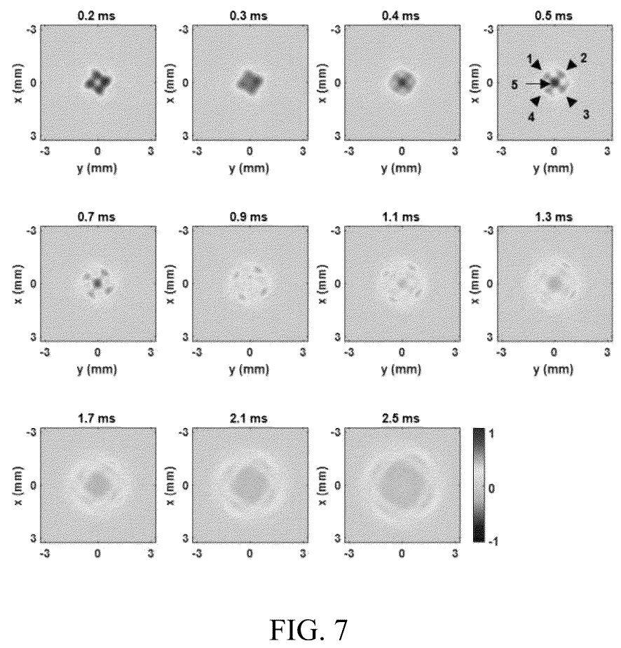

Referring to FIG. 7, FIG. 7 is a schematic diagram of a shear wavefront transmission according to various embodiments of the present invention.

To observe overlapping of a shear wave wavefront, a wavefront transmission generated by the foregoing four shear wave sources in a range of 0.2 ms to 2.5 ms is exemplarily described. On a focus xy plane, an acoustic vortex generates four shear wave sources in a periodicity of 200 ns. The four shear wave sources respectively generate, on a time axis, a shear wave transmission expanding around at a speed of 0.8 m/s. The shear wave transmission is overlapped at 0.5 ms, as shown at marks 1 to 5 in FIG. 7. A new shear wave source is constructively interfered at an empty axis position, and the new shear wave source is a constructive interference shear wave source.

The shear wave transmission continues to expand around at the speed of 0.8 m/s in a range of 0.5 ms to 2.5 ms, to present a wavefront transmission of a concentric circular shear wave and form shear wave imaging.

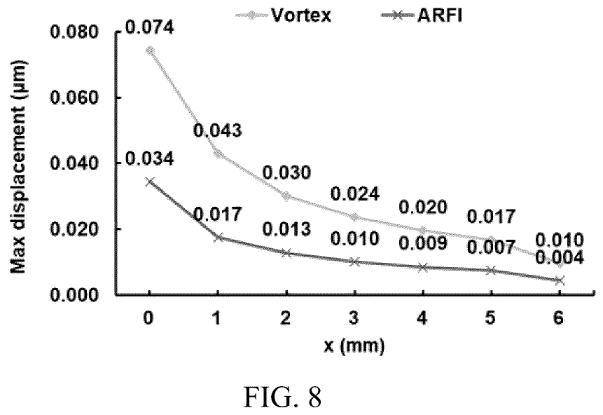

Last, referring to FIG. 8, FIG. 8 is a schematic diagram of an exemplary axial particle displacement according to the present invention.

In FIG. 8, as a transmission distance along an x-axis increases, displacements at x=1, 2, 3, 4, 5, and 6 mm are respectively 2.5, 2.4, 2.3, 2.3, 2.3, and 2.2 times of an acoustic radiation force impulse. This indicates that attenuation of an acoustic vortex is large in a transmission process, and attenuation of the acoustic vortex is compensated by a displacement increased by constructive interference. Consequently, the displacement of the acoustic vortex is higher than a displacement of the acoustic radiation force impulse in a transmission distance of 6 mm.

Therefore, the maximum axial displacement caused by the acoustic vortex at different positions in an x direction can be known, and a result shows that a displacement when x=0 mm is 2.2 times of the acoustic radiation force impulse.

In conclusion, in a method for enhancing shear wave imaging based on an acoustic vortex of the present invention, a two-dimensional array whose central frequency is 5 MHz transmits a vortex waveform to induce shear wave elastography, and four shear wave sources are generated at different positions in a transverse direction at a time interval of a quarter periodicity (50 ns) through a phase delay characteristic of a waveform, to induce a constructive interference shear wavefront in the transverse direction and increase a displacement generated in a tissue without increasing ultrasonic wave output. Therefore, a stronger shear wave amplitude is generated, a transmission distance of the shear wave is increased, and an objective of expanding a field of view range of elastography is achieved.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for enhancing shear wave imaging based on an acoustic vortex, comprising the following steps:
transmitting an ultrasonic beam in an acoustic vortex waveform to a target tissue through an ultrasonic transducer;
sensing an original wave source generated by the ultrasonic beam through the target tissue;
forming, by the original wave source, at least one shear wave source in a unit periodicity;
responding to generate, by the shear wave source, a constructive interference shear wave source; and
generating a shear wave through the constructive interference shear wave source, and obtaining tissue characteristic information based on the shear wave, wherein an image of a displacement generated by the shear wave is drawn through the tissue characteristic information.

2. The method for enhancing shear wave imaging based on an acoustic vortex according to claim 1, wherein the ultrasonic transducer comprises an ultrasonic probe emitting an acoustic vortex, and the ultrasonic probe is configured to generate a plurality of ultrasonic beams to transmit the ultrasonic beams to the target tissue.

3. The method for enhancing shear wave imaging based on an acoustic vortex according to claim 2, wherein the ultrasonic probe is a two-dimensional array probe.

4. The method for enhancing shear wave imaging based on an acoustic vortex according to claim 1, wherein a central frequency of the ultrasonic beam is in a range of 1 MHz to 10 MHz.

5. The method for enhancing shear wave imaging based on an acoustic vortex according to claim 1, wherein the step of the forming, by the original wave source, at least one shear wave source in a unit periodicity further comprises: correspondingly establishing at least one action area based on transverse acoustic field distribution of the original wave source.

6. The method for enhancing shear wave imaging based on an acoustic vortex according to claim 5, wherein the step of the correspondingly establishing at least one action area based on transverse acoustic field distribution of the original wave source further comprises: generating, by the at least one shear wave source, constructive interference in the action area.

7. The method for enhancing shear wave imaging based on an acoustic vortex according to claim 6, wherein the step of the generating, by the at least one shear wave source, constructive interference in the action area further comprises: increasing, by the at least one shear wave source, a displacement for the target tissue because of the constructive interference, to improve amplitude strength of the shear wave.

8. The method for enhancing shear wave imaging based on an acoustic vortex according to claim 1, wherein the step of the generating a shear wave through the constructive interference shear wave source further comprises: determining elasticity of the target tissue through the shear wave.

9. The method for enhancing shear wave imaging based on an acoustic vortex according to claim 1, wherein the tissue characteristic information comprises at least one of arrival time of the shear wave, a peak displacement of the shear wave, an axial displacement of the shear wave, rise time of the shear wave, fall time of the shear wave, and a normalized distribution diagram of the shear wave.
